(19) United States
(12) Patent Application Publication
(10) Pub. No.: US 2013/0160722 A1
(43) Pub. Date: Jun. 27, 2013

(54) HYBRID VEHICLE WITH EXHAUST POWERED TURBO GENERATOR

(71) Applicant: HYBRID ELECTRIC CONVERSION CO., LLC, Miami, FL (US)

(72) Inventor: Ronald Kyle, Akron, OH (US)

(73) Assignee: HYBRID ELECTRIC CONVERSION CO., LLC, Miami, FL (US)

(21) Appl. No.: 13/770,132

(22) Filed: Feb. 19, 2013

Related U.S. Application Data
(63) Continuation of application No. 13/476,614, filed on May 21, 2012.
Application No. 13/476,614 is a continuation of application No. 11/233,847, filed on Sep. 23, 2005, now abandoned.
Application No. 11/233,847 is a continuation-in-part of application No. 11/181,318, filed on Jul. 14, 2005, now abandoned.
(60) Provisional application No. 60/599,906, filed on Aug. 9, 2004.
(60) Provisional application No. 60/618,881, filed on Oct. 14, 2004.
(60) Provisional application No. 60/626,556, filed on Nov. 10, 2004.
(60) Provisional application No. 60/631,310, filed on Nov. 29, 2004.
(60) Provisional application No. 60/664,043, filed on Mar. 22, 2005.
(60) Provisional application No. 60/664,052, filed on Mar. 22, 2005.
(60) Provisional application No. 60/664,309, filed on Mar. 22, 2005.
(60) Provisional application No. 60/671,567, filed on Apr. 15, 2005.

(51) Int. Cl. F02B 75/00

(52) U.S. Cl. CPC F02B 75/00
USPC 123/2

(57) ABSTRACT

A hybrid vehicle employing an internal combustion engine and an electric drive includes a turbine powered by exhaust gases from the internal combustion engine. The turbine drives a generator which provides electrical power to the electric drive motor and the electrical power storage system for the drive, usually comprising a battery. This exhaust gas energy recovery system may be used with either a serial hybrid system in which the internal combustion engine powers another generator or a parallel system in which both the mechanical outputs of the internal combustion and electric motor are combined to drive the vehicle.

### CROSS-REFERENCE TO RELATED APPLICATIONS

This application is a continuation of U.S. patent application Ser. No. 13/476,614 filed May 21, 2012, which is a continuation of U.S. patent application Ser. No. 11/233,847 filed Sep. 23, 2005, which is a continuation-in-part of U.S. patent application Ser. No. 11/181,318 filed Jul. 14, 2005, which claims priority of U.S. Provisional Application Ser. Nos. 60/599,906 filed Aug. 9, 2004; 60/618,881 filed Oct. 14, 2004; 60/626,556 filed Nov. 10, 2004; 60/631,310 filed Nov. 29, 2004; 60/664,043 filed Mar. 22, 2005; 60/664,052 filed Mar. 22, 2005; 60/664,309 filed Mar. 22, 2005; and 60/671,567 filed Apr. 15, 2005.

### FIELD OF THE INVENTION

This invention relates to vehicles including automotive vehicles and boats which are powered by hybrid systems including both internal combustion and electric drives, and more particularly to such a system employing a turbine driven by the exhaust gases from the internal combustion engine to power a generator which provides electric power to the electric drive motor and storage system.

### BACKGROUND OF THE INVENTION

Hybrid drive systems for vehicles, and automotive vehicles in particular, which employ both internal combustion engines and electric motors, provide a number of advantages over conventional systems powered solely by an internal combustion engine or an electric drive system. All electric drive systems, employing a large power storage system, typically a battery, possibly with auxiliary storage capacitors, suffer from the disadvantage that the weight and cost of the batteries severely limits vehicle range between rechargings. Accordingly, electric vehicles are typically used only for limited range urban delivery vehicles, buses and golf carts. On the other hand, vehicles powered solely by an internal combustion engine suffer from the fact that internal combustion engines only have a high thermal efficiency in a limited speed and power range, typically chosen to be the cruising speed of the vehicle. Unlike electric drive motors, which provide maximum torque at startup speeds, internal combustion engines provide very little torque at limited speeds, and heavy and expensive transmissions must be provided. The need to provide accelerating power at high speeds requires that engines be over-powered for their typical cruising speeds. Additionally, the dynamic energy represented by the momentum of the vehicle is lost as heat to the atmosphere during braking while in an electric powered vehicle that energy can be recaptured by so-called “regenerative braking” in which the momentum of the vehicle is converted into electric power which can be stored for later application to the electric drive system.

By providing both electric and internal combustion engine drive systems, as is done in a hybrid vehicle, the inefficiency of the internal combustion during startup and high speed acceleration can be minimized through using the electric drive system at these times and the braking energy may be recovered for later use. This is true in both a serial hybrid system, in which an internal combustion engine, operating at relatively constant speed and load, drives a generator to power the electric drive and storage system, or a parallel hybrid system wherein the mechanical outputs of both the internal combustion engine and electric drive are combined to power the vehicle. Hybrid vehicles thus exhibit substantially greater fuel economy than similar vehicles powered solely by internal combustion engines, and the harmful emissions from such engines are substantially decreased.

Independently, exhaust gas turbines are often employed with internal combustion engines to power compressors which feed air to the engine cylinders during acceleration to boost the nominal power of the engine. These turbochargers use energy in the exhaust gases of the internal combustion engine which would otherwise be dissipated to the atmosphere. However, these exhaust turbochargers inherently operate only during acceleration. They do not inherently improve fuel efficiency other than by decreasing the size and weight of an engine required to provide good performance during high speed acceleration.

### SUMMARY OF THE INVENTION

The present invention is directed toward a hybrid vehicle which utilizes an exhaust gas driven turbine to power a generator or alternator which provides its power to the electric drive and storage system of the vehicle during operation of the internal combustion engine. This arrangement conserves exhaust gas energy, which would otherwise be dissipated to the atmosphere, and converts that energy into electric power which minimizes the power demands on the internal combustion engine. In this arrangement a greater percentage of the drive power for the hybrid powered vehicle can be provided by the electric drive system compared to a hybrid vehicle in which the exhaust gas energy is not used to produce electric energy for the drive system.

The exhaust gas turbine of the present invention is designed in such a way as to minimize the exhaust system restriction and thus avoid lowering the thermal efficiency of the internal combustion engine. In systems which employ catalytic converters, the exhaust gas turbine is preferably located downstream in the exhaust system with respect to the converter so that the converter may take maximum advantage of the high exhaust gas temperature to achieve combustion of the exhaust products before they are provided to the turbine and the exhaust provided to the turbine has a higher heat content than the exhaust exiting the engine manifold because of the combustion of the unburned hydrocarbons in the converter.

By providing electric power that may be derived from an exhaust gas turbine, the power storage capacities, and thus the battery weight and cost, may be minimized in a hybrid vehicle. Since battery weight and cost represent significant engineering restraints on a hybrid vehicle design, use of the exhaust gas turbine substantially improves performance and lowers the cost of a hybrid vehicle.

A preferred embodiment of the invention, which will be subsequently disclosed in detail, employs gearing between the exhaust gas turbine and the generator which it drives to reduce the turbine speed to generator level. In the preferred embodiment this gearing takes the form of a planetary gear set integrated with the generator. The generator is preferably a permanent-magnet generator so as to avoid the potential deleterious effects of the exhaust gases on the coils of an electromagnet.

In another preferred embodiment of the invention, the turbine employs air bearings to minimize frictional losses, and electric power may be used to drive the generator as a motor to jumpstart the turbine rotor to the required speed for the air bearing to operate. The preferred embodiment employs a high voltage electrical system, such as 200 volts, at high frequencies such as 200 Hz, to minimize the current-dependent losses through the electric system. An inverter may be employed between the generator and the electrical system to achieve these high voltages.

### BRIEF DESCRIPTION OF THE DRAWINGS

Other objects, advantages and applications of the present invention will be described in the following detailed description of a preferred embodiment of the invention. The description makes reference to the accompanying drawings in which:

FIG. 1 is a schematic view of a parallel hybrid vehicle employing a drive combining both electric and internal combustion engines, wherein an internal combustion engine exhaust drives a turbine to generate electric power which is provided to the batteries and/or the electric drive motor, forming the preferred embodiment of the invention; and

FIG. 2 is a schematic diagram of details of a preferred embodiment of the exhaust system turbine driving an alternator through a gear-reducing drive.

### DETAILED DESCRIPTION OF THE INVENTION

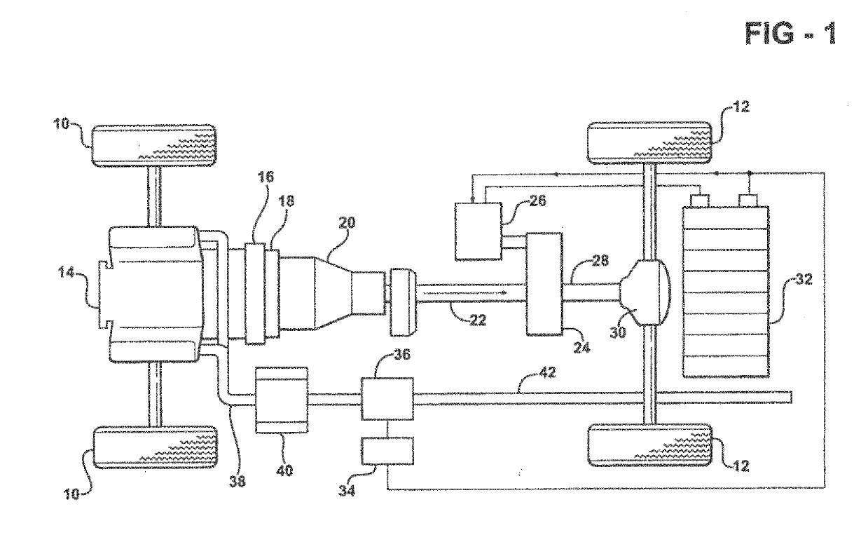

Referring to FIG. 1, a parallel hybrid vehicle is illustrated; that is one in which both internal combustion and electric drives contribute to power the drive wheels. The present invention is equally applicable to other varieties of hybrid vehicles, such as serial hybrids in which an internal combustion engine drives an alternator which provides power to a battery and/or an electric drive motor for the wheels. FIG. 1 is representative of a vehicle having front wheels 10 and rear wheels 12. An internal combustion engine 14 may be fueled by gasoline or diesel, or powered by an unconventional fuel. The engine 14 conventionally incorporates accelerator and brake pedals (not shown) and provides its output to a flywheel 16. The mechanical output of the engine, through the flywheel 16, may be connected to a torque converter 18 and/or a transmission 20. The transmission provides its output to a driveshaft 22.

The driveshaft 22 provides one driving input to a transfer case 24. The other driving input to the transfer case 24 is provided by an electric motor-generator 26. The transfer case 24 includes gearing which combines power from the two inputs, and may include an electrically actuated clutch for disengaging the driveshaft 22 from the output of the transfer case represented by shaft 28, so the engine 14 may be turned off during stops. The shaft 28, which may be powered by the drive shaft input from the internal combustion engine 14 or the driving output of the electric motor 26, or both, is provided to the rear wheels through a differential 30.

The vehicle may be operated in various modes in which either the mechanical output of the internal combustion engine, through the driveshaft 22, is provided to the output shaft 28, or the output of the electric motor 26 is provided to the output shaft 28, or both are provided. Operation is coordinated by a controller (not shown) of conventional type.

The electric drive motor 26 is powered by a battery bank 32 which may consist of conventional lead acid batteries but preferably comprises more advanced types such as lithium batteries, hydride batteries, or other batteries having a higher power density.

As heretofore described, the hybrid vehicle is conventional. The present invention adds electric power for charging the batteries of battery bank 32 or powering the motor 26 directly, from a generator or alternator 34 which is powered by an exhaust gas driven turbine 36. The exhaust gases from the manifolds of the internal combustion engine are directed by an exhaust system 38 to a catalytic converter 40 of conventional type, wherein the unburned hydrocarbons in the exhausts are burned, and the output of the catalytic converter is provided to the turbine 36 and then into the atmosphere through a tailpipe 42. The turbine 36 may be of any conventional design including multi-stage axial flow designs, simple turbines, or the like. The rotary output of the turbine drives the generator/alternator 34 to provide a power source for the batteries 32. The batteries 32 may also be charged by electric output from the motor-generator 26 when it is driven by the shaft 28 during regenerative braking of the vehicle. That is, rather than providing the braking force through friction materials as in conventional vehicles, these friction materials are aided or supplanted by dissipating the momentum of the vehicle through driving the motor-generator 26 to provide power to the battery bank 32. This power, along with the electric power provided by the generator/alternator 34, provides a source of electric power for driving the vehicle alone or supplanting the power provided by the internal combustion engine.

The system may include various inverters and transformers to make appropriate changes to the system voltage and/or frequency. The system is preferably of relatively high frequency such as 200-400 cycles and a high voltage such as 200-400 volts to minimize resistive losses.

By converting the energy in the exhaust into electric power, the fuel economy of the vehicle is substantially improved. The range of operations in which only electric power may be used to drive the vehicle may be substantially increased.

The system also preferably incorporates a connector for receiving power from conventional stationary electric power sources, to charge the battery during periods of nonuse of the vehicle, or to provide electrical power from the vehicle to power appliances and the like. Suitable rectifiers, inverters and transformers may be associated with such operation.

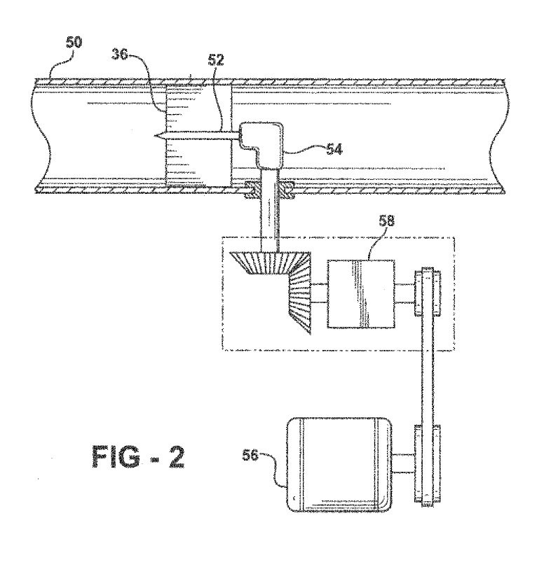

FIG. 2 illustrates the detailed configuration of the exhaust gas turbine 36 disposed within an exhaust pipe 42. The output shaft 52 of the turbine may be connected to a right angle drive 54 which powers an alternator 34 disposed exteriorly of the exhaust system through a suitable gear reduction drive 58 which may be of the planetary variety.

Having thus described my invention, I claim:

1. A hybrid automotive vehicle, comprising:
an internal combustion engine having a manifold connected to receive its exhaust gases and having an output shaft;
an electric motor-generator having an output shaft;
a transfer case connected to the output shafts of the internal combustion engine and the motor-generator and having an output driveshaft;
driven wheels powered by the output driveshaft of the transfer case;
an electric storage system comprising a battery;
a catalytic converter connected to the engine manifold to receive exhaust gases from the engine;
an exhaust turbine connected to receive exhaust gases passing out of the catalytic converter and operative to power an output shaft;
an electric generator connected to receive the full energy output of the exhaust turbine output shaft;
a first electrical connection between the motor-generator and the electric storage system to provide electric power to the storage system when the motor-generator output shaft is driven by the transfer case during vehicle braking; and
a second electric connection between the electric generator and both the storage system and the motor-generator to provide electrical power from the generator to the battery and the motor-generator during operation of the internal combustion engine.

2. The hybrid vehicle of claim 1, further comprising a gear reduction unit between the exhaust turbine and the electric generator.
